(19) United States
(12) Patent Application Publication
(10) Pub. No.: US 2005/0137914 A1
(43) Pub. Date: Jun. 23, 2005

(54) Method, computer program product, and system for calculating a premium for stop loss insurance for a fleet of vehicles

(76) Inventors: Hans Schmitter, Zurich (CH); Henryk Faas, Zurich (CH)

Correspondence Address: PILLSBURY WINTHROP SHAW PITTMAN LLP, 1650 TYSONS BOULEVARD, MCLEAN, VA, 22102, US

(21) Appl. No.: 11/004,872

(22) Filed: Dec. 7, 2004

Related U.S. Application Data
(60) Provisional application No. 60/532,253, filed on Dec. 23, 2003.

(51) Int. Cl. G06F 17/60

(52) U.S. Cl. 705/4

(57) ABSTRACT

A premium for stop loss insurance for a fleet of vehicles is calculated as a stop loss premium for an assumed loss distribution having only losses with a value of one of zero and maximum individual loss. The stop loss premium is calculated based on a loss frequency, a maximum individual loss, and a deductible. The loss frequency is calculated by dividing an expected total loss by the maximum individual loss. Subsets of the fleet of vehicles are associated with different treaty durations. For each treaty duration a stop loss premium is calculated for the fleet of vehicles. Subsequently, for each treaty duration a premium is calculated for the subset of the fleet of vehicles associated with the treaty duration by weighting the stop loss premium, calculated for the fleet of vehicles, with the number of vehicles in the subset. Without having to store and process complex distributions of individual losses of the fleet of vehicles, a worst-case premium for stop loss insurance for the fleet of vehicles can be calculated. Repetitive steps used in the prior art for discretizing and processing distributions of individual losses can be eliminated, and thus, processing time and processing power can be reduced.

### FIELD OF THE INVENTION

The present invention relates to a computer-implemented method and devices for calculating an insurance premium. Specifically, the present invention relates to a computer-implemented method, a computer program product, and a computer-based data processing system for calculating a premium for stop loss insurance for a fleet of vehicles.

### BACKGROUND OF THE INVENTION

Estimating the loss potential and pricing of a treaty is central to the underwriting process. Usually, pricing methods work with ‘static’ input (distributions) to yield a ‘static’ premium. In certain cases, however, input parameters may not be known with sufficient certainty (e.g. loss experience) or can be subject to change (treaty conditions). In these cases, it is important to determine the sensitivity of the premium (or expected loss) to changes in input parameters, e.g. deductible.

In long term renting of vehicles, typically, fleet operators rent to individuals or companies for a duration of 1 to 5 years. By outsourcing its fleet to a specialized provider, a company can expect to save considerable costs. In consequence, the business sees a greater increase over the past years. For example, in Spain about 7% of all newly licensed vehicles belong to this category. Growing by 22% in 2001, the number of renting vehicles in Spain reached 265,000 vehicles in 2002 (statistics from the Asociaci6n Espanola de Renting). Fleet operators take over all administration of the vehicles, including agreements with service providers, e.g. garages and insurers. Regarding motor hull damages, fleet operators may be willing to retain some financial risk, but seek balance sheet protection through insurance instruments more typical of Reinsurance than Insurance.

For example, renting of vehicles is shifting the demand for motor hull insurance in the Spanish market. Instead of standard, per vehicle insurance handled by insurers, a balance sheet protection is sought, which is better achieved by Reinsurance instruments.

What is missing are a method and tools suitable for estimating efficiently and flexibly the loss potential and pricing of an insurance treaty for fleets of vehicles.

### SUMMARY OF THE INVENTION

It is an object of this invention to provide an improved computer-implemented method, an improved computer program product, and an improved computer-based data processing system for calculating a premium for stop loss insurance for a fleet of vehicles; particularly, a premium for stop loss reinsurance for the fleet of vehicles.

According to the present invention, the above-mentioned objects are particularly achieved in that for calculating a premium for stop loss insurance for a fleet of vehicles, particularly, a premium for stop loss reinsurance for the fleet of vehicles, an expected total loss for the fleet of vehicles is determined, a maximum individual loss, equivalent to a cost of a most expensive vehicle of the fleet, is stored in a computer, a loss frequency is calculated by the computer by dividing the expected total loss by the maximum individual loss, a deductible, payable by an insurance holder, is stored in the computer, and the premium is calculated by the computer based on the loss frequency, the maximum individual loss, and the deductible, as a stop loss premium for an assumed loss distribution having only losses with a value of one of zero and maximum individual loss. Generally, if the probability distribution of individual losses is known for the fleet of vehicles, the stop loss premium can be calculated. For probability distributions having the same maximum individual loss and the same average individual loss or aggregated total loss, respectively, Gagliardi and Straub have shown that a probability distribution having only individual losses with a value of either zero or the maximum individual loss is the worst case probability distribution resulting in the highest stop loss premium [Gagliardi and Straub (1974): “Eine obere Grenze fur Stop-Loss-Prämien”, Mitteilungen der Vereinigung schweizerischer Versicherungs-mathematiker 1974, volume 2, pages 215 to 221]. Consequently, a worst case or upper bound stop loss premium can be calculated for an assumed loss distribution having only losses with a value of either zero or the maximum individual loss. For that purpose, the (assumed) loss frequency is calculated by dividing the expected total loss by the maximum individual loss. Therefore, without having to know and without having to store and process complex distributions of individual losses of the fleet of vehicles, a worst case (and thus safe) premium for stop loss insurance for the fleet of vehicles can be calculated based solely on the expected total loss, the maximum individual loss, and a deductible payable by the insurance holder. Consequently, for calculating the premium, repetitive steps used in the prior art for discretizing and processing distributions of individual losses can be eliminated, and thus, processing time and processing power can be reduced. Furthermore, memory space used in the prior art for storing distributions of individual losses, for storing discretized distributions of individual losses, and for storing intermediate processing results can be saved. Incorporating the Gagliardi/Straub method for calculating a premium for stop loss insurance for a fleet of vehicles according to the present invention reduces processing time, and thus, makes it possible to reduce operating time for negotiating with a client from several hours to a few minutes.

In a preferred embodiment, subsets of the fleet of vehicles are associated in the computer with different treaty durations. For each treaty duration, a separate premium is calculated by the computer for the subset of the fleet of vehicles associated with the treaty duration. Subsequently, the premium for the fleet of vehicles is calculated by the computer by aggregating the separate premiums.

Preferably, for each treaty duration, a stop loss premium is calculated by the computer for the fleet of vehicles. Moreover, for each treaty duration, a premium is calculated by the computer for the subset of the fleet of vehicles associated with the treaty duration by weighting the stop loss premium, calculated for the fleet of vehicles, with the number of vehicles in the subset. Thus, as discussed above in the context of calculating the premium for stop loss insurance for the fleet of vehicles, the premium can be calculated efficiently for fleets of vehicles having subsets associated with different treaty durations. There is no need for storing or processing distributions of individual losses. In addition to the expected total loss, the maximum individual loss, and the deductible, only the number of vehicles in the different subsets must be known for calculating the premium for stop loss insurance for the whole fleet of vehicles.

Preferably, for each treaty duration, a duration-dependent loss frequency is calculated by the computer by dividing an expected total loss for the treaty duration by the maximum individual loss. Moreover, based on the duration-dependent loss frequency, the maximum individual loss, and a deductible assigned to the treaty duration, a stop loss premium is calculated by the computer for the fleet of vehicles for each treaty duration. The stop loss premium is calculated by the computer for an assumed loss distribution having only losses with a value of one of zero and maximum individual loss. For each treaty duration, a premium is calculated by the computer for the subset of the fleet of vehicles associated with the treaty duration by dividing the stop loss premium for the treaty duration by the total number of vehicles in the fleet and by the treaty duration, and by multiplying the stop loss premium for the treaty duration with the number of vehicles in the subset. In addition to the above-stated advantages, different deductibles can be specified for the different treaty durations, thus enabling insurance holders to define different scenarios for short term and long-term risks.

In an embodiment, stop loss premiums for the fleet of vehicles are calculated by the computer for different treaty durations. For each treaty duration, the computer calculates a stop loss premium per vehicle by dividing the stop loss premium, calculated for the treaty duration and for the fleet of vehicles, with the number of vehicles in the fleet. In the computer, subsets of the fleet of vehicles are associated with the different treaty durations. For each treaty duration, a premium is calculated by the computer for the subset of the fleet of vehicles associated with the treaty duration by multiplying the stop loss premium per vehicle, calculated for the respective treaty duration, with the number of vehicles in the respective subset. Stop loss premiums per vehicle for each treaty duration can be calculated at a time when the portfolio distribution, i.e. the number of vehicles of the fleet associated with the different treaty durations, is not known yet, for example at the time when the contract of the stop loss insurance is prepared. At a later time, when the portfolio distribution is known, the premium for each treaty duration can be calculated by multiplying the stop loss premium per vehicle for the respective treaty duration with the number of vehicles associated with the respective treaty duration. Consequently, it is possible for an insurance holder and/or for an insurance provider to calculate easily the premium for each treaty duration (and through aggregation the premium for the fleet of vehicles) as an estimate for an expected portfolio distribution or as a very accurate approximation for a known portfolio distribution.

Preferably, for each treaty duration, a duration-dependent loss frequency is calculated by the computer by dividing an expected total loss for the treaty duration by the maximum individual loss. The expected total loss for a multi-year treaty duration is calculated by the computer by adding an expected total loss for each year included in the multi-year treaty.

Preferably, an expected total loss for a first year of a multi-year treaty is calculated by the computer by multiplying an expected number of incidents, expected in the first year, with an average individual loss amount for an incident involving one of the vehicles. An expected total loss for one of the years after the first year of the multi-year treaty is calculated by the computer by multiplying an expected total loss of a preceding year with an index. Finally, an expected total loss for the multi-year treaty is calculated by the computer by aggregating expected total losses for years included in the multi-year treaty. Time-dependent indexing of the expected total loss has the advantage that monetary inflation, on one hand, and age-dependent devaluation of a vehicle, on the other hand, can be considered for multi-year treaties.

In an embodiment, a maximum total insurance coverage is stored in the computer and, based on the loss frequency, the maximum individual loss, and the maximum total insurance coverage, a premium excess is calculated by the computer as a stop loss premium for an assumed loss distribution having only losses with a value of one of zero and maximum individual loss. At least a defined part of the premium excess is subtracted by the computer from the premium. Calculating and subtracting the premium excess from the premium has the advantage that the premium is not charged for losses exceeding the maximum total insurance coverage, i.e. for losses not covered by the insurance.

In an embodiment, the premium is calculated by the computer for defined values of the deductible and a graphical representation is produced by the computer, showing the premium as a function of the defined values of the deductible. The deductible payable by the insurance holder is selected based on the graphical representation. Illustrating the premium for the stop loss insurance as a function of the deductible makes it possible for the insurance holder to specify a deductible, knowing the corresponding premium, or vice versa.

In an embodiment, determining the expected total loss includes entering 5 and storing in the computer risk factors and calculating by the computer the expected total loss based on the risk factors. Moreover, a graphical representation is produced by the computer, showing the premium as a function of the risk factors. Typically, risk factors have a direct influence on the number of incidents and/or on the individual loss amount, and thus, on the expected total loss. For example, a geographical area where vehicles are frequently stolen represents a quantifiable risk factor, having a direct influence on the expected number of incidents and on the expected total loss. Illustrating the premium as a function of risk factors has the advantage that the influence of risk factors on the premium, as well as the impact of reducing specific risk factors, can be illustrated to the insurance holder.

In an embodiment, the premium is calculated by the computer for defined values of the expected number of incidents and a graphical representation is produced by the computer, showing the premium as a function of the defined values of the expected number of incidents. Illustrating the premium as a function of the expected number of incidents has the advantage that the influence of the expected number of incidents on the premium, as well as the impact of reducing the expected number of incidents, can be illustrated to the insurance holder.

Preferably, determining the expected total loss includes storing in the computer an expected number of incidents involving one of the vehicles, storing in the computer an expected average individual loss amount for an incident involving one of the vehicles, and calculating by the computer the expected total loss by multiplying the expected number of incidents with the expected average individual loss amount.

In addition to a computer-implemented method and a computer-based data processing system for calculating a premium for stop loss insurance for a fleet of vehicles, the present invention also relates to a computer program product including computer program code means for controlling one or more processors of a computer, particularly, a computer program product including a computer readable medium containing therein the computer program code means.

### BRIEF DESCRIPTION OF THE DRAWINGS

The present invention will be explained in more detail, by way of example, with reference to the drawings in which:

FIG. 1 shows an example of a time sequence of incidents having individual loss amounts and a chart illustrating the corresponding stop loss cover.

FIG. 2 shows block diagram illustrating schematically an exemplary configuration of a computer-based data processing system for practicing embodiments of the present invention, said configuration comprising a computer with a processor and memory.

FIG. 3 shows a block diagram illustrating schematically the interdependencies between various variables and a premium for stop loss insurance.

FIG. 4 shows a block diagram illustrating schematically an exemplary configuration of programmed software modules for practicing embodiments of the present invention.

FIG. 5 shows a block diagram illustrating schematically an exemplary configuration of data flow and processing for practicing embodiments of the present invention for calculating a premium for stop loss insurance for a fleet of vehicles.

FIG. 6 shows a block diagram illustrating schematically an exemplary configuration of data flow and processing for practicing embodiments of the present invention for calculating a premium for stop loss insurance for a fleet of vehicles, defined subsets of the fleet being associated with different treaty durations.

FIG. 6b shows a block diagram illustrating schematically an exemplary configuration of data flow and processing for practicing embodiments of the present invention for calculating a premium for stop loss insurance for a fleet of vehicles, stop loss premiums being calculated per vehicle for different treaty durations.

FIG. 7 shows a graph illustrating the premium for stop loss insurance as a function of the deductible.

FIG. 8 shows a graph illustrating the premium for stop loss insurance as a function of the frequency of incidents.

FIG. 9 shows a graph illustrating the premium for stop loss insurance as a function of the number of vehicles.

FIG. 10 shows a graph illustrating the premium for stop loss insurance as a function of a defined percentage of robberies actually observed.

### DETAILED DESCRIPTION OF THE PREFERRED EMBODIMENTS

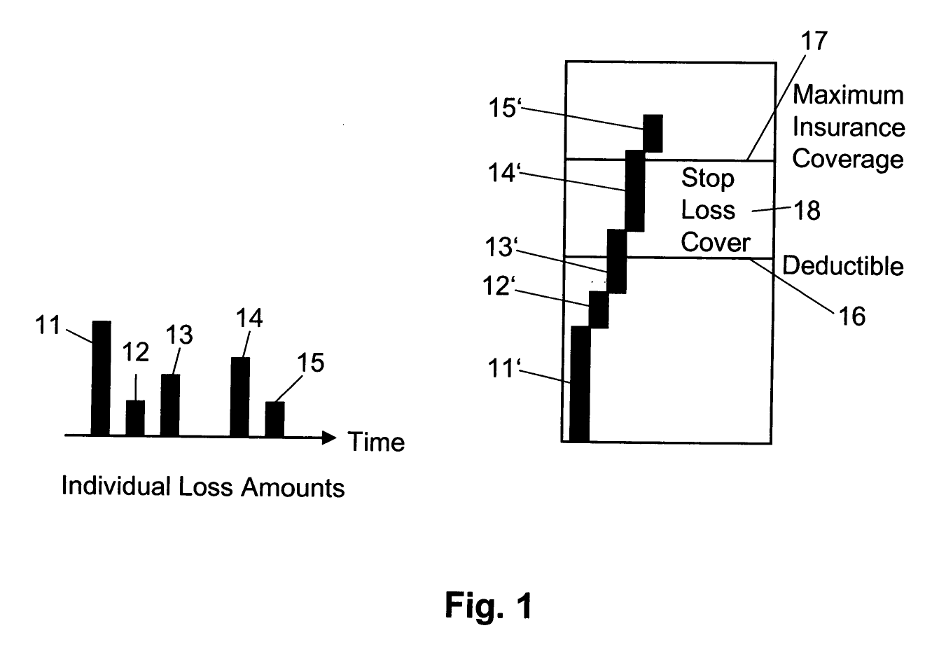

In FIG. 1, reference numerals 11, 12, 13, 14, and 15 refer to individual loss amounts caused by a corresponding time sequence of incidents, for example vehicle accidents or vehicle thefts. Reference numerals 11′, 12′, 13′, 14′, and 15′ refer to the individual loss amounts arranged vertically to illustrate the aggregation of the individual loss amounts over time. Reference numeral 16 relates to a deductible, having a value of 115% in the illustrated example. The deductible 16 defines the portion of the aggregated individual loss amounts 11′, 12′, 13′, 14′, 15′ that is to be paid by an insurance holder. Reference numeral 18 relates to a stop loss cover, i.e. a range of the aggregated individual loss amounts 11′, 12′, 13′, 14′, 15′ for which insurance coverage is provided. As is illustrated in FIG. 1, the stop loss cover 18 is limited by a maximum insurance coverage 17 (also referred to as exit point), having a value of 150% in the illustrated example. The insurer does not cover any aggregated loss exceeding the exit point.

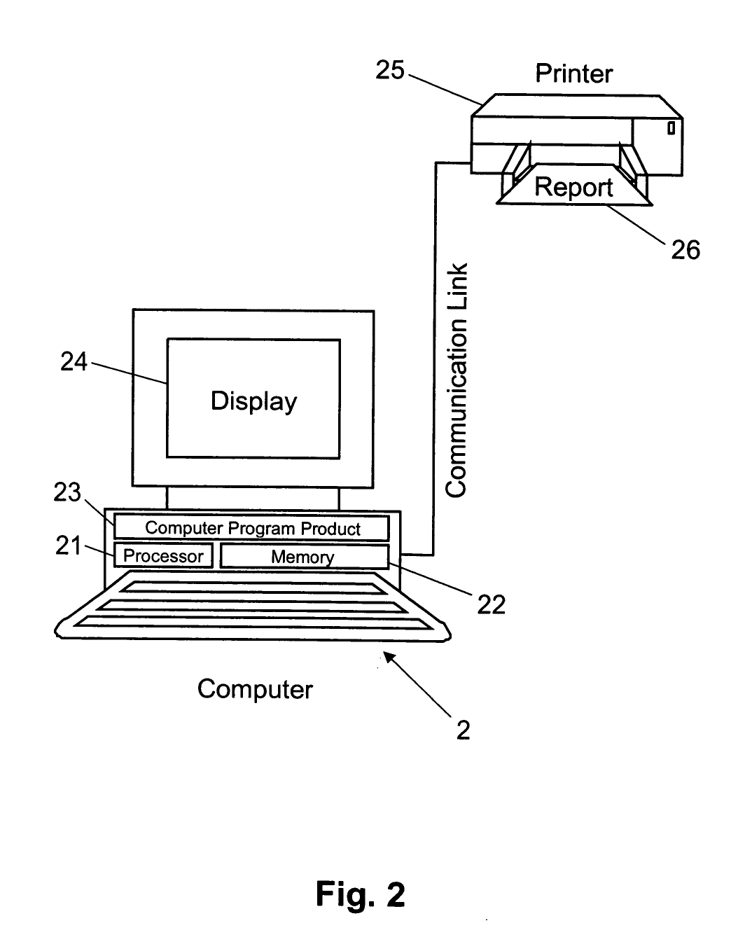

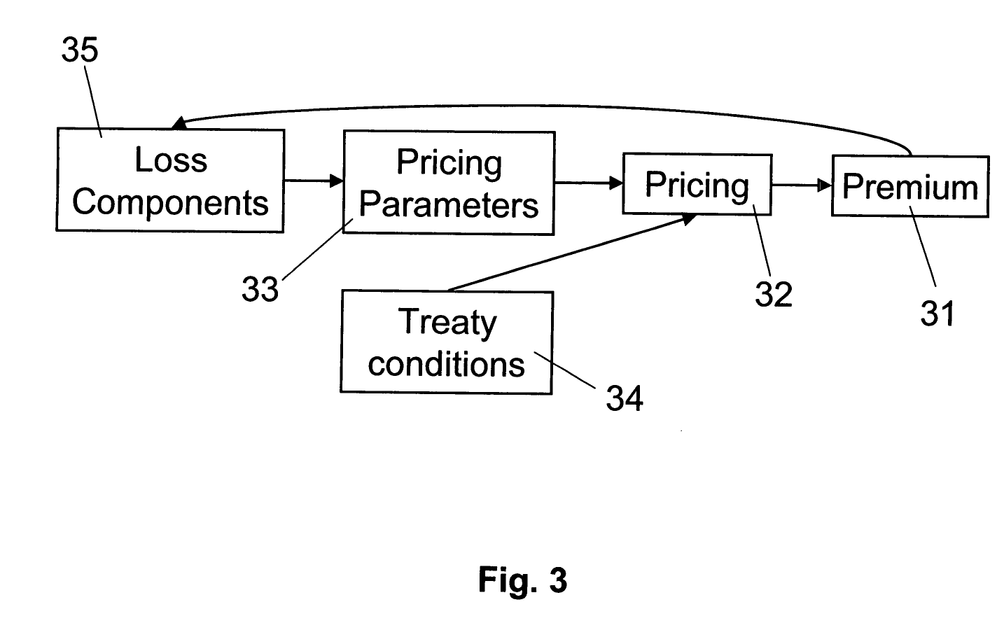

In FIG. 2, reference numeral 2 refers to a computer-based data processing system, particularly a computer such as a personal computer. As is illustrated schematically, computer 2 includes a display 24, at least one processor 21, memory 22 for storing data and programs, as well as a computer program product 23. The computer program product 23 comprises computer program code for controlling processor 21 so that the computer 2 executes various functions described below in more detail with reference to FIGS. 3, 4, 5 and 6. Particularly, the computer program product 23 comprises computer program code for calculating a premium for stop loss insurance for a fleet of vehicles. The computer program code is stored in a computer readable medium, either in memory integrated in computer 2 or on a data carrier that can be inserted into computer 2. The computer 2 is connected via communication link 27 to printer 25.

In FIG. 3, illustrated are the interdependencies between various variables and the premium 31 for stop loss insurance. The premium 31 is determined by pricing module 32. The pricing module 32 determines the premium 31 based on pricing parameters 33 and treaty conditions 34. The pricing parameters are influenced by loss components 35. The pricing parameters 33 include the average cost per incident (i.e. the average individual loss amount), the incident frequency (e.g. the number of incidents per year), the number of vehicles in the fleet to be insured, a portfolio distribution, and an index, preferably a loss inflation index. For a portfolio including multiple treaties having different treaty durations (i.e. multi-year treaties), the portfolio distribution indicates the number of vehicles of the fleet associated with each treaty. In Table 1, an example of a portfolio distribution is shown for different treaties having individual treaty durations of one, two, three, four, or five years, respectively. The treaty conditions 34 include a maximum individual loss amount, i.e. the maximum single loss that is equivalent to the most expensive vehicle in the fleet. The treaty conditions 34 also include information about the treaty structure. The information about the treaty structure includes a deductible, payable by the insurance holder, and a maximum insurance coverage (exit point). It is possible to associate and store different deductibles and/or exit points for different treaty durations. The loss components include information about a client's loss experience. The loss experience includes the number of losses or incidents by type of loss or incident (e.g. theft of the vehicle), date of loss or incident, place of loss or incident (e.g. type of place, such as highway, inner city, or suburbs; and/or geographical location, including information such as country, state/province, and city). Each loss or incident also includes a unique identifier and a detailed description of the incident, for example a description of an accident.

TABLE 1

| Treaty | Distribution | Distribution |
|---|---|---|
| Duration | (percentage) | (numbers) |
| 1 Year | 6% | 192 |
| 2 Years | 24% | 708 |
| 3 Years | 40% | 1,200 |
| 4 Years | 26% | 792 |
| 5 Years | 4% | 108 |

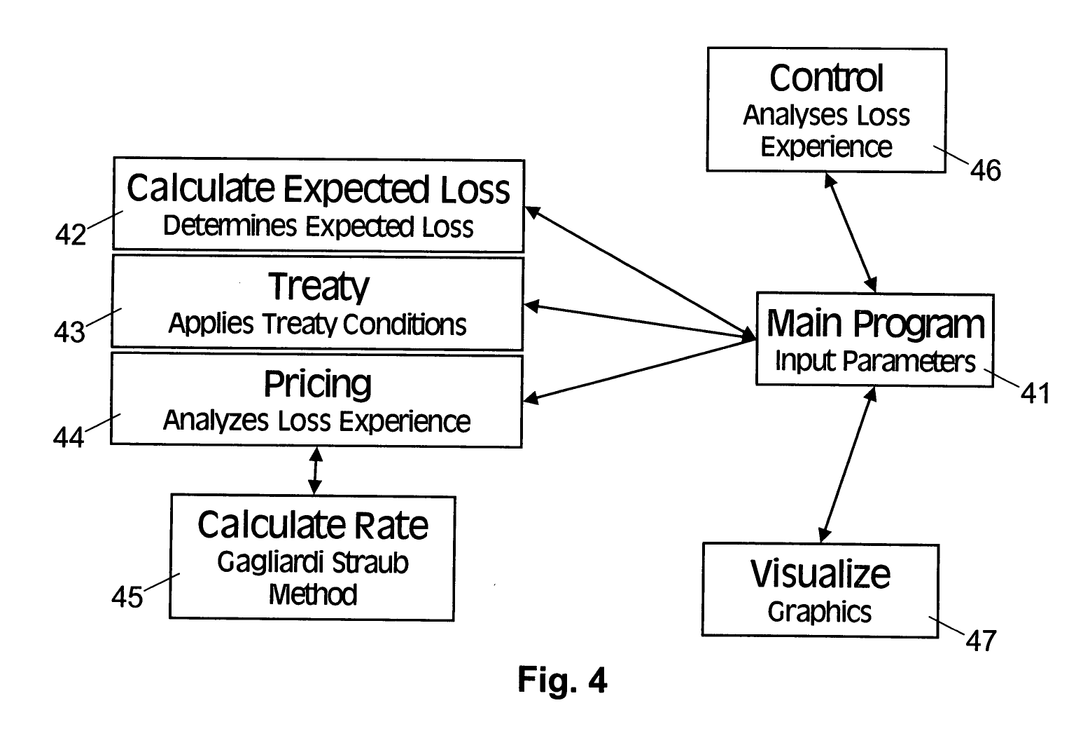

One skilled in the art will understand that the computer program code, included in the computer program product 23, may be implemented as one program application, as multiple separate program application modules or as program extension modules for conventional spreadsheet applications, such as Microsoft Excel, for example. In FIG. 4, an exemplary configuration of programmed software modules for practicing embodiments of the present invention is illustrated. As illustrated in FIG. 4, computer 2 includes a main program module 41, an expected loss calculation module 42, a treaty module 43, a pricing module 44, a calculate rate module 45, a control module 46, as well as a visualization module 47.

The main program module 41 is responsible for receiving and storing input parameters needed for calculating the premium for stop loss insurance for a fleet of vehicles. The input parameters include the average cost per incident, the incident frequency, the number of vehicles to be insured, the portfolio distribution, the index (e.g. the loss inflation index), the treaty structure, and the maximum individual loss. It is also possible to have the average cost per incident and the incident frequency calculated based on loss experience information and/or risk factors, as will be explained later in more detail.

The expected loss calculation module 42 calculates the expected total loss by multiplying the average cost per incident (expected average individual loss amount for an incident involving one of the vehicles) with the incident frequency (expected yearly number of incidents involving one of the vehicles). Furthermore, for fleets having subsets of vehicles associated with different treaty durations, the expected loss calculation module 42 calculates the expected total loss for treaty durations of one, two, three, four and five years, for example. For multi-year treaties, the expected loss for the years after the first year is calculated by multiplying the expected total loss for the preceding year with an index. Preferably, the index is a loss inflation index. The expected total loss for multi-year treaties having treaty durations of two, three, four, and five years, is calculated by aggregating the expected total losses for the years included in the respective multi-year treaty.

The treaty module 43 is responsible for applying the treaty conditions to calculations and simulations.

The pricing module 44 is used to analyze the loss experience. Particularly, the pricing module 44 is used to determine the average cost per incident and the incident frequency based on loss experience information and/or risk factors. Most input parameters, for example the average individual loss amount, are better described by a distribution rather than a fixed value. In the present invention the Monte Carlo method is used for risk calculation, allowing a user to determine the probability level of a result. The pricing module 44 invokes the expected loss calculation module 42, the treaty module 43, and the calculate rate module 45 for calculating a premium for the stop loss insurance for the fleet of vehicles. The pricing module 44 is also configured to provide reverse pricing for determining treaty parameters based on a set total premium. For example, if a client is willing to allocate a defined total sum for the premium, key parameters of the treaty, such as the deductible, are calculated for the specified premium.

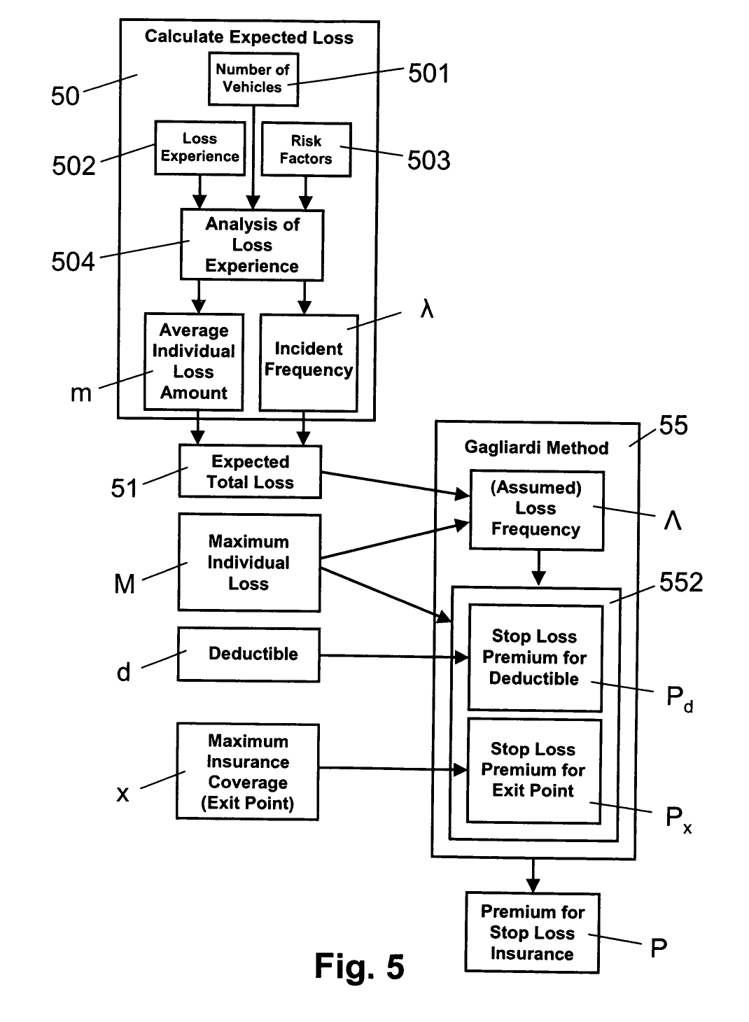

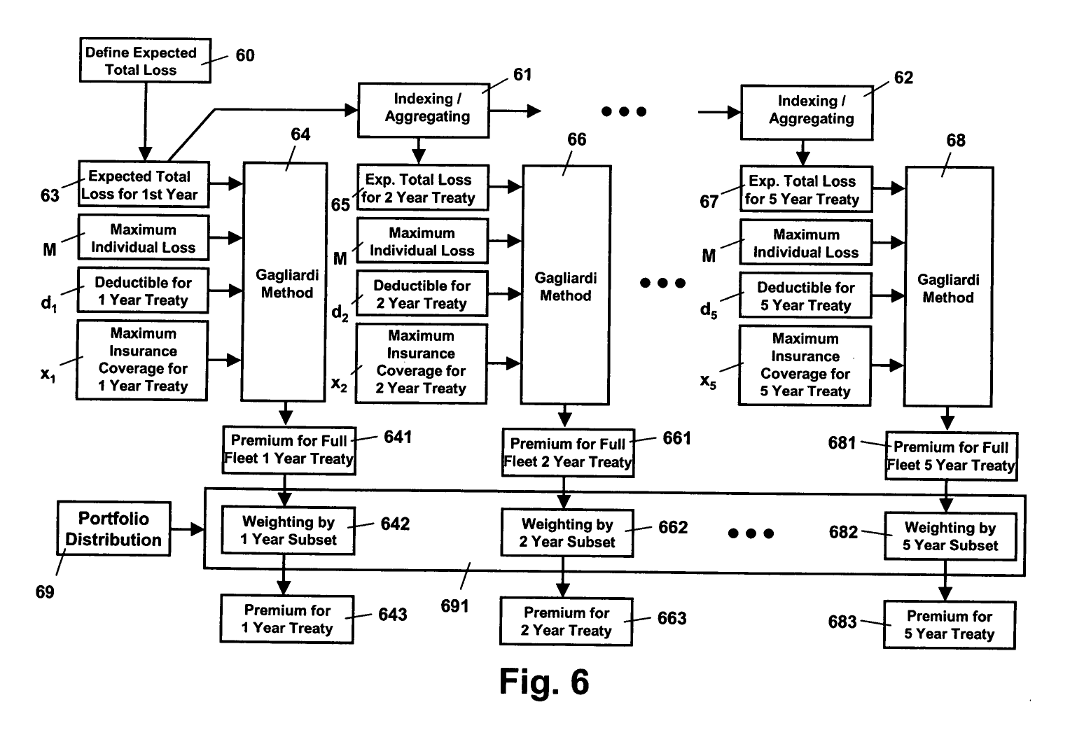

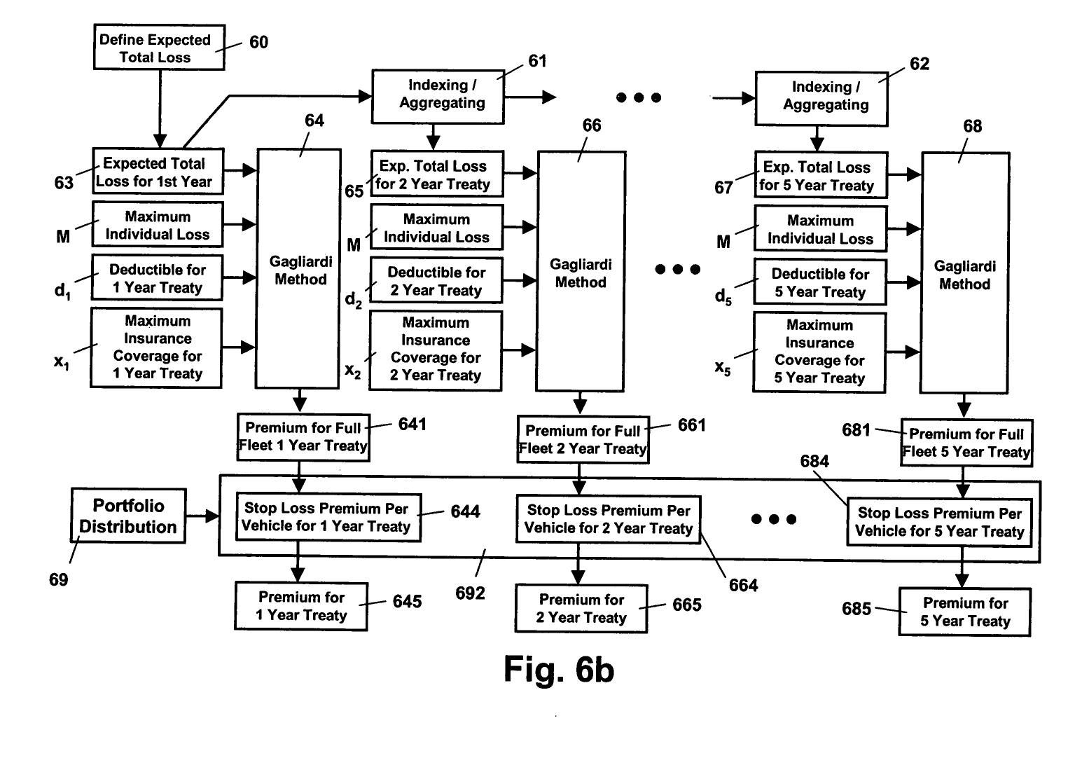

Using the Gagliardi/Straub method (or Gagliardi method for short), the calculate rate module 45 calculates a premium for stop loss insurance for a fleet of vehicles or for a defined subset of the fleet, respectively, as will be explained in more detail with reference to FIGS. 5 and 6.

The control module 46 can also be used to analyze the loss experience. Particularly, the control module 46 is used for sensitivity analysis and simulations, i.e. for assessing how the premium changes if specific input parameters are changed. For example, specific input parameters and risk factors are selectable and for a selected input parameter or risk factor, the premium is calculated for different values of the selected input parameter or risk factor. These simulated results are illustrated graphically on display 24 or on a report 26 printed on printer 25. Results are simulated based on the interdependencies of certain parameters.

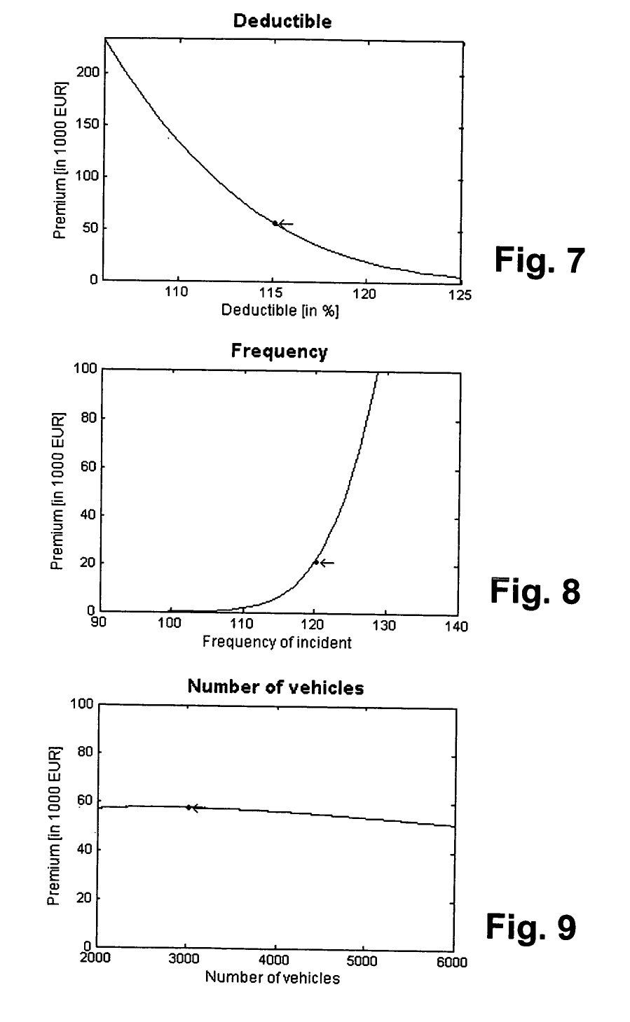

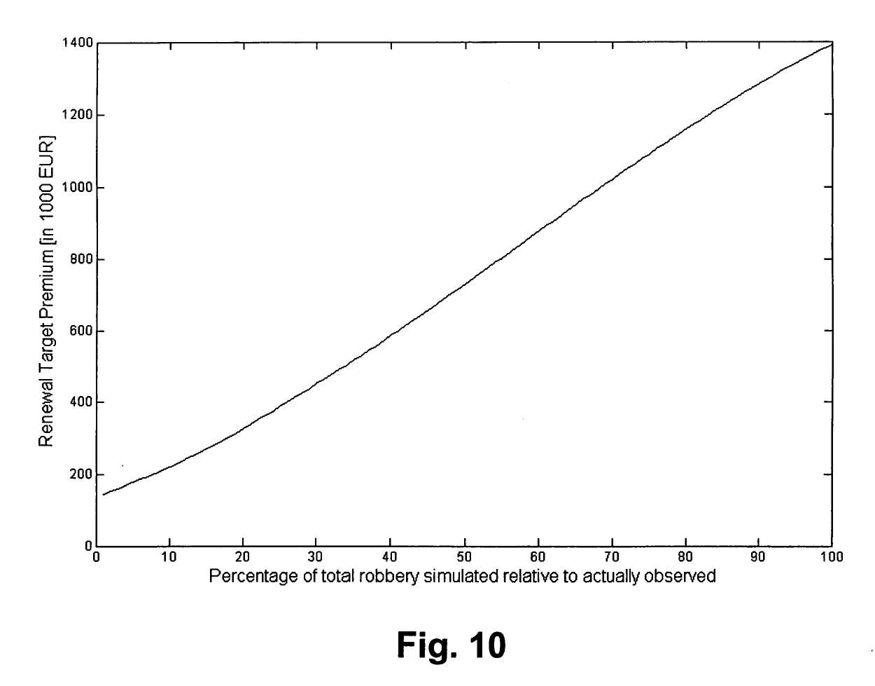

The visualization module 47 is responsible for visualizing selected information in graphical form. For example, the visualization module 47 displays graphs of simulated scenarios showing the impact of different variables (e.g. input parameters or risk factors) on the premium. In FIGS. 7, 8, and 9, examples of graphs are shown, illustrating the premium for stop loss insurance as a function of the deductible, as a function of the frequency of incidents, or as a function of the number of vehicles, respectively. In FIG. 10, an example of a graph is shown, illustrating the premium for stop loss insurance as a function of a risk factor. Particularly, FIG. 10 illustrates the premium for stop loss insurance as a function of a defined percentage of robberies (theft of vehicles) actually observed. Preferably, the visual images are displayed on display 24 in a graphical interface. The visual images refresh automatically when one or more of the input parameters are changed. The visual images can also be reproduced on a report 26 printed on printer 24.

As is illustrated in FIG. 5, the expected total loss 51 is calculated in block 50. The expected total loss 51 is calculated by multiplying the expected average individual loss m by the expected incident frequency λ. The expected average individual loss m and/or the expected incident frequency λ are entered into computer 2 or calculated in block 504. Block 504 analyzes the loss experience 502 and calculates the expected average individual loss m and the expected incident frequency A based on the loss experience 502 and the number of vehicles 501. In addition, Block 504 uses risk factors 503 to calculate the expected average individual loss m and the expected incident frequency λ.

In block 55, according to Gagliardi/Straub, an assumed loss frequency Λ is calculated by dividing the expected total loss 51 by the maximum individual loss M.

The maximum individual M loss, the deductible d, as well as the maximum insurance coverage (exit point) x are values entered and stored in computer 2. The maximum individual loss M and the loss frequency Λ are passed to block 552. The deductible d is passed to block 553 and the maximum insurance coverage (exit point) x is passed to block 554.

In block 552, according to Gagliardi/Straub, a stop loss premium P_{d} is calculated for the deductible d based on the loss frequency Λ, the maximum individual loss M and the deductible d. The stop loss premium P_{d} is calculated according to formula (1) for an assumed loss distribution having only losses with either a value of zero or maximum individual loss M, wherein k=Integer(d/M).

$${P}_{d} = Λ \cdot M \cdot ( 1 - {\sum }_{j = 0}^{k - 1} {e}^{- Λ} \cdot \frac{{Λ}^{j}}{j !} ) - d \cdot ( 1 - {\sum }_{i = 0}^{k} {e}^{- Λ} \cdot \frac{{Λ}^{i}}{i !} ) \qquad ( 1 )$$

Furthermore, in block 552, according to Gagliardi/Straub, a stop loss premium Pₓ is calculated for the maximum insurance coverage (exit point) x based on the loss frequency A, the maximum individual loss M and the exit point x. The stop loss premium Pₓ is calculated according to formula (2) for an assumed loss distribution having only losses with either a value of zero or maximum individual loss M, wherein k=Integer(x/M).

$${P}_{x} = Λ \cdot M \cdot ( 1 - {\sum }_{j = 0}^{k - 1} {e}^{- Λ} \cdot \frac{{Λ}^{j}}{j !} ) - x \cdot ( 1 - {\sum }_{i = 0}^{k} {e}^{- Λ} \cdot \frac{{Λ}^{i}}{i !} ) \qquad ( 2 )$$

An example of a computer program function for calculating stop loss premiums P_{d} and Pₓ according to formulas (1) or (2), respectively, is shown in Table 2.

TABLE 2

Public Function STOPLOSS (exp_loss As Double,
max_loss As Double, prio As Double)
Dim frequency As Double
Dim sum_a As Double
Dim sum_b As Double
Dim k As Integer
Dim j As Integer
Dim i As Integer
k = Int(prio / max_loss)
frequency = exp_loss / max_loss
p_i = Exp(−1 * frequency)
p_i = Exp(−1 * frequency)
sum_a = p_i
sum_b = p_i
For j = 1 To (k − 1)
p_j = p_j * (frequency / j)
sum_a = sum_a + p_j
Next j
For i = 1 To k
p_i = p_i * (frequency / i)
sum_b = sum_b + p_i
Next i
STOPLOSS = frequency * max_loss * (1 − sum_a) −
prio * (1 − sum_b)
End Function

Finally, in block 552, the premium P for the stop loss insurance for the fleet of vehicles is calculated according to formula (3). The factor c (0≦c≦1) should correct for the fact that a subtraction of two upper limits for the stop loss premium is not necessarily itself an upper limit for the layer.
P=P_{d}−c·Px (3)

In FIG. 6, calculation of the premium for stop loss insurance is illustrated for a fleet of vehicles having subsets of the fleet associated with different treaty durations. In the example illustrated in FIG. 6, the treaties have durations of one, two, three, four, and five years. However, in FIG. 6, only calculations for the multi-year treaties having two and five years are explicitly shown; the multi-year treaties having a duration of three and four years are indicated symbolically only by periods (“ . . . ”).

The expected total loss for the first year 63 is calculated in block 60. Block 60 corresponds to block 50 described above with reference to FIG. 5.

For multi-year treaties, the expected total losses are each calculated by adding the aggregated losses expected for years included in the treaty duration. The aggregated losses expected for years after the first year are calculated by indexing the expected total loss for the first year 63, i.e. by multiplying the expected total loss for the first year 63 with an index, preferably an inflation index. For example, in block 61, the expected total loss 65 is calculated for the multi-year treaty having duration of two years (i.e. the two year treaty). The expected total loss for the two-year treaty 65 is calculated by adding the expected total loss for the first year 63 and the expected aggregated loss for the second year. The expected aggregated loss for the second year is calculated by indexing the expected total loss for the first year 63. In block 62, the expected total loss 67 is calculated for the five-year treaty. The expected total loss for the five-year treaty 67 is calculated by adding the expected total loss for the first year 63 and the expected aggregated losses for the second, the third, the fourth, and the fifth year.

As is illustrated in FIG. 6, the same maximum individual loss amount M is used for the one-year treaty as well as for the multi-year treaties. However, different deductibles d₁, d₂, d₅ can be entered and stored in computer 2 for each of the treaties. Moreover, it is also possible to enter and store different maximum insurance coverage values (exit points) x₁, x₂, x₅ for each of the treaties.

In block 64, the stop loss the premium for the full fleet of vehicles is calculated according to Gagliardi/Straub for the one-year treaty. Block 64 corresponds to block 55 described above with reference to FIG. 5. Block 64 calculates the premium for the one-year treaty for the full fleet based on the expected total loss for the first year 63, the maximum individual loss amount M, the deductible d₁ for the one-year treaty, and the maximum insurance coverage (exit point) x₁ for the one-year treaty.

For multi-year treaties, the stop loss premiums for the full fleet of vehicles are calculated according to Gagliardi/Straub based on the respective expected total loss calculated for the respective treaty. For the multi-year treaties, the stop loss premiums for the full fleet of vehicles are calculated according to Gagliardi/Straub based on the deductible d₂, d₅ and the maximum insurance coverage (exit point) x₂, x₅ assigned to the respective treaty. For example, in block 66, the stop loss premium for the full fleet of vehicles is calculated for the two-year treaty based on the expected total loss for the two-year treaty 65, the maximum individual loss amount M, the deductible d₂ for the two-year treaty, and the maximum insurance coverage (exit point) x₂ for the two-year treaty. In block 68, the stop loss the premium for the full fleet of vehicles is calculated for the five-year treaty based on the expected total loss for the five-year treaty 67, the maximum individual loss amount M, the deductible d₅ for the five-year treaty, and the maximum insurance coverage (exit point) x₅ for the five-year treaty.

In block 691, the stop loss premiums 641, 661, 681 calculated for the different treaty durations for the full fleet of vehicles are weighted by the actual number of vehicles in the respective subset associated with the treaty duration. For that purpose, the portfolio distribution 69 is passed to block 691. Moreover, the stop loss premiums 641, 661, 681 calculated for the multi-year treaties are converted into yearly rates. For example, in block 642, the premium for the stop loss insurance for the one-year treaty 643 is calculated. In block 642, the premium for the one-year treaty for the full fleet 641 is divided by the number of vehicles 501 of the fleet and multiplied by the number of vehicles in the subset associated with the one-year treaty. In block 662, the yearly premium for the stop loss insurance for the two-year treaty 663 is calculated. In block 662, the premium for the two-year treaty for the full fleet 661 is divided by the number of vehicles 501 of the fleet, multiplied by the number of vehicles in the subset associated with the two-year treaty, and divided by the two-year duration. In block 682, the yearly premium for the stop loss insurance for the five-year treaty 683 is calculated. In block 682, the premium for the five-year treaty for the full fleet 681 is divided by the number of vehicles 501 of the fleet, multiplied by the number of vehicles in the subset associated with the five-year treaty, and divided by the five-year duration.

The total yearly premium for stop loss insurance for the full fleet is calculated by aggregating the yearly premiums 643, 663, 683 for the stop loss insurance for the different treaty durations.

Since renting firms are usually start-up companies, most input values are only approximately known, so rather than calculating only a fixed premium, the present invention determines the impact of a parameter on the price (premium) of the insurance. This often leads to adaptations in the treaty. For example, a reasonable upper limit for the loss per vehicle can be determined and included in the price of the insurance. Also, other high impact parameters can be monitored and/or simulated.

In FIG. 6b, for a fleet of vehicles having subsets of the fleet associated with different treaty durations, the calculation of stop loss premiums per vehicle for each treaty duration is illustrated. In block 692, the stop loss premiums 641, 661, 681 calculated for the different treaty durations for the full fleet of vehicles are divided by the number of vehicles in the fleet. For example, in block 644, the stop loss premium per vehicle for the one-year treaty is calculated and stored; in block 664, the stop loss premium per vehicle for the two-year treaty is calculated and stored; and in block 684, the stop loss premium per vehicle for the five-year treaty is calculated and stored. Once the portfolio distribution 69 is known (or provided as an estimate) and passed to block 692, the premiums for the stop loss insurance for the different treaties are calculated in block 692. For example, the premium for the stop loss insurance for the one-year treaty 645 is calculated by multiplying the stored stop loss premium per vehicle for the one-year treaty 644 with the number of vehicles associated with the one-year treaty. The premium for the stop loss insurance for the two-year treaty 665 is calculated by multiplying the stored stop loss premium per vehicle for the two-year treaty 664 with the number of vehicles associated with the two-year treaty. The premium for the stop loss insurance for the five-year treaty 685 is calculated by multiplying the stored stop loss premium per vehicle for the five-year treaty 684 with the number of vehicles associated with the five-year treaty.

Typically, the precise portfolio distribution is known only after the beginning of the stop loss insurance. Consequently, the calculated premium for stop loss insurance may be too high or too low, if the portfolio distribution was not estimated correctly at the beginning of the insurance contract. For example, an average individual loss of 1,000, an expected incident frequency of 10%, a number of vehicles of 5,000, a maximum individual loss of 100,000, an assumed percentage of 80% of the fleet associated with a one-year treaty, and an assumed percentage of 20% of the fleet associated with a two-year treaty, results an expected total loss for the one-year treaty of 80%·5,000·10%·1,000=400,000 and an expected total loss for the two-year treaty of 20%·5,000·10%·1,000=100,000 (in two years 200,000). Assuming an 115% stop loss deductible of the expected total loss (600,000) of 690,000, the precise premium of the stop loss insurance, calculated according to the method described herein, is 60941. However, if the portfolio distribution turns out to have a percentage of 20% of the fleet associated with the one-year treaty and an percentage of 80% of the fleet associated with the two-year treaty, the precise premium of the stop loss insurance would be 6,089 (about 10%) higher (the value calculated for the assumed portfolio distribution is too low). In our example, the stop loss premium per vehicle for the one-year treaty is 11.79; the stop loss premium per vehicle for the two-year treaty is 13.65. For a portfolio distribution with a percentage of 80% of the fleet associated with the one-year treaty and a percentage of 20% of the fleet associated with the two-year treaty, the premium for the stop loss insurance is 5,000·80%·11.79+5000·20%·13.65=60,810. For a portfolio distribution with a percentage of 20% of the fleet associated with the one-year treaty and a percentage of 80% of the fleet associated with the two-year treaty, the premium for the stop loss insurance is 5,000·20%·11.79+5000·80%·13.65=66,390. In both cases, the difference to the precise premium for stop loss insurance is negligibly small. In Table 3, the difference between the approximation, based on the stop loss premium per vehicle, and the precise calculation of the premium for the stop loss insurance is listed for different portfolio distributions.

TABLE 3

| | | | | | Approx- |
|---|---|---|---|---|---|
| | | | | | imation |
| | | | | | in % of |
| | | | Precise | | precise |
| | | | premium | | premium |
| Percentage | Percentage | | for stop | | for |
| of one-year | of two-year | Stop loss | loss | Approx- | stop loss |
| treaties | treaties | deductible | insurance | imation | insurance |
| 0 | 100 | 1150000 | 68253 | 68253 | 100 |
| 10 | 90 | 1092500 | 66787 | 67321 | 101 |
| 20 | 80 | 1035000 | 67030 | 66389 | 99 |
| 30 | 70 | 977500 | 66142 | 65456 | 99 |
| 40 | 60 | 920000 | 65256 | 64524 | 99 |
| 50 | 50 | 862500 | 64968 | 63592 | 98 |
| 60 | 40 | 805000 | 62819 | 62660 | 100 |
| 70 | 30 | 747500 | 63146 | 61728 | 98 |
| 80 | 20 | 690000 | 60941 | 60795 | 100 |
| 90 | 10 | 632500 | 60512 | 59863 | 99 |
| 100 | 0 | 575000 | 58931 | 58931 | 100 |

As can be seen in Table 3, calculating the premium of the stop loss insurance from the stop loss premiums per vehicle, calculated for individual treaty durations, provides a very good approximation to the precise calculation of the premium of the stop loss insurance with known portfolio distribution.

In order to proof that (U+V)⁺≦U⁺+V⁺ (inequation 1) is true for random variables U and V, the following three cases must be reviewed: (a) U+V≦0; (b) U+U<0; and (c) U>0, V>0.

Let us assume that X₁ and X₂ are two expected losses, that P₁ and P₂ are the respective stop loss deductibles, and that 0≦a≦1.
a·X₁+(1−a)·X₂ is a weighted expected loss.
a·P₁+(1−a)·P₂ is a weighted stop loss deductible.
It is: (a·X₁+(1−a)·X₂−[a·P₁+(1−a)·P₂])⁺=(a·[X₁−P₁]+(1−a)·[X₂−P₂])⁺.

If one sets U=a·(X₁−P₁) and V=a·(X₂−P₂), then, according to inequation (1), the expression above is ≦a·(X₁−P₁)⁺+(1−a)·(X₂−P₂)⁺.

If on both sides of the inequation the expected value is formed, inequation (2) follows as indicated below:
E{(a·X₁+(1−a)·X₂−[a·P₁+(1−a)·P₂])⁺}≦a·E([X₁−P₁]⁺)+(1−a)·E([X₂−P₂]⁺).

The left side of inequation (2) is the stop loss premium of the weighted expected loss; the right side of inequation (2) is the weighted stop loss premium of the individual expected losses.

However, in the method for calculating the premium for stop loss insurance according to the present invention (incorporating the Gagliardi/Straub method), one is not dealing with weighted values of expected losses X₁ and X₂, but the Poisson distributed number of losses are weighted, whereas the maximum values of the losses remain unchanged. Therefore, in Table 3, approximations are not always higher than the precise value but often lower. However, for practical purposes, the differences are insignificant.

1. A computer-implemented method for calculating a premium for stop loss insurance for a fleet of vehicles, the method including:
determining an expected total loss for the fleet of vehicles;
storing in a computer a maximum individual loss equivalent to a cost of a most expensive vehicle of the fleet;
calculating by the computer a loss frequency by dividing the expected total loss by the maximum individual loss;
storing in the computer a deductible payable by an insurance holder; and
calculating by the computer the premium based on the loss frequency, the maximum individual loss, and the deductible as a stop loss premium for an assumed loss distribution having only losses with a value of one of zero and maximum individual loss.

2. The method according to claim 1, wherein the method further includes associating in the computer subsets of the fleet of vehicles with different treaty durations; wherein for each treaty duration a separate premium is calculated by the computer for the subset of the fleet of vehicles associated with the treaty duration; and wherein the premium for the fleet of vehicles is calculated by the computer by aggregating the separate premiums.

3. The method according to claim 1, wherein the method further includes associating in the computer subsets of the fleet of vehicles with different treaty durations; wherein for each treaty duration a stop loss premium is calculated by the computer for the fleet of vehicles; and wherein for each treaty duration a premium is calculated by the computer for the subset of the fleet of vehicles associated with the treaty duration by weighting the stop loss premium, calculated for the fleet of vehicles, with the number of vehicles in the subset.

4. The method according to claim 1, wherein the method further includes associating in the computer subsets of the fleet of vehicles with different treaty durations; wherein for each treaty duration a duration-dependent loss frequency is calculated by the computer by dividing an expected total loss for the treaty duration by the maximum individual loss; wherein a stop loss premium is calculated by the computer for the fleet of vehicles for each treaty duration based on the duration-dependent loss frequency, the maximum individual loss, and a deductible assigned to the treaty duration, the stop loss premium being calculated for an assumed loss distribution having only losses with a value of one of zero and maximum individual loss; and wherein for each treaty duration a premium is calculated by the computer for the subset of the fleet of vehicles associated with the treaty duration by dividing the stop loss premium for the treaty duration by the total number of vehicles in the fleet and by the treaty duration, and by multiplying the stop loss premium for the treaty duration with the number of vehicles in the subset.

5. The method according to claim 1, wherein the method further includes calculating by the computer stop loss premiums for the fleet of vehicles for different treaty durations; wherein for each treaty duration a stop loss premium per vehicle is calculated by the computer by dividing the stop loss premium, calculated for the treaty duration and for the fleet of vehicles, with the number of vehicles in the fleet; wherein the method further includes associating in the computer subsets of the fleet of vehicles with the different treaty durations; and wherein for each treaty duration a premium is calculated by the computer for the subset of the fleet of vehicles associated with the treaty duration by multiplying the stop loss premium per vehicle, calculated for the respective treaty duration, with the number of vehicles in the respective subset.

6. The method according to claim 1, wherein the method further includes associating in the computer subsets of the fleet of vehicles with different treaty durations; wherein for each treaty duration a duration-dependent loss frequency is calculated by the computer by dividing an expected total loss for the treaty duration by the maximum individual loss, the expected total loss for a multi-year treaty duration being calculated by adding an expected total loss for each year included in the multi-year treaty.

7. The method according to claim 6, wherein an expected total loss for a first year of a multi-year treaty is calculated by the computer by multiplying an expected number of incidents, expected in the first year, with an average individual loss amount for an incident involving one of the vehicles; wherein an expected total loss for one of the years after the first year of the multi-year treaty is calculated by the computer by multiplying an expected total loss of a preceding year with an index; and wherein an expected total loss for the multi-year treaty is calculated by the computer by aggregating expected total losses for years included in the multi-year treaty.

8. The method according to claim 1, wherein the method further includes storing in the computer a maximum total insurance coverage, and calculating by the computer a premium excess based on the loss frequency, the maximum individual loss, and the maximum total insurance coverage as a stop loss premium for an assumed loss distribution having only losses with a value of one of zero and maximum individual loss; and wherein calculating the premium includes subtracting at least a defined part of the premium excess from the premium.

9. The method according to claim 1, wherein the method further includes calculating by the computer the premium for defined values of the deductible and producing by the computer a graphical representation showing the premium as a function of the defined values of the deductible; and wherein the deductible payable by the insurance holder is selected by an insurance holder based on the graphical representation.

10. The method according to claim 1, wherein determining the expected total loss includes entering and storing risk factors in the computer and calculating by the computer the expected total loss based on the risk factors; and wherein the method further includes producing by the computer a graphical representation showing the premium as a function of the risk factors.

11. The method according to claim 1, wherein the method further includes calculating by the computer the premium for defined values of the expected number of incidents, and producing by the computer a graphical representation showing the premium as a function of the defined values of the expected number of incidents.

12. The method according to claim 1, wherein determining the expected total loss includes storing in the computer an expected number of incidents involving one of the vehicles, storing in the computer an expected average individual loss amount for an incident involving one of the vehicles, and calculating by the computer the expected total loss by multiplying the expected number of incidents with the expected average individual loss amount.

13. Computer program product comprising computer program code means for controlling one or more processors of a computer, such that the computer determines an expected total loss for a fleet of vehicles to be insured by stop loss insurance;
that the computer stores a maximum individual loss equivalent to a cost of a most expensive vehicle of the fleet;
that the computer calculates a loss frequency by dividing the expected total loss by the maximum individual loss;
that the computer stores a deductible payable by an insurance holder; and that the computer calculates a premium for the insurance based on the loss frequency, the maximum individual loss, and the deductible as a stop loss premium for an assumed loss distribution having only losses with a value of one of zero and maximum individual loss.

14. The Computer program product according to claim 13, comprising further computer program code means for controlling the one or more processors of the computer such that the computer associates subsets of the fleet of vehicles with different treaty durations; that the computer calculates for each treaty duration a separate premium for the subset of the fleet of vehicles associated with the treaty duration; and that the computer calculates the premium for the fleet of vehicles by aggregating the separate premiums.

15. The Computer program product according to claim 13, comprising further computer program code means for controlling the one or more processors of the computer such that the computer associates subsets of the fleet of vehicles with different treaty durations; that the computer calculates for each treaty duration a stop loss premium for the fleet of vehicles; and that the computer calculates for each treaty duration a premium for the subset of the fleet of vehicles associated with the treaty duration by weighting the stop loss premium, calculated for the fleet of vehicles, with the number of vehicles in the subset.

16. The Computer program product according to claim 13, comprising further computer program code means for controlling the one or more processors of the computer such that the computer associates subsets of the fleet of vehicles with different treaty durations; that the computer calculates for each treaty duration a duration-dependent loss frequency by dividing an expected total loss for the treaty duration by the maximum individual loss; that the computer calculates a stop loss premium for the fleet of vehicles for each treaty duration based on the duration-dependent loss frequency, the maximum individual loss, and a deductible assigned to the treaty duration, the stop loss premium being calculated for an assumed loss distribution having only losses with a value of one of zero and maximum individual loss; and that the computer calculates for each treaty duration a premium for the subset of the fleet of vehicles associated with the treaty duration by dividing the stop loss premium for the treaty duration by the total number of vehicles in the fleet and by the treaty duration, and by multiplying the stop loss premium for the treaty duration with the number of vehicles in the subset.

17. The Computer program product according to claim 13, comprising further computer program code means for controlling the one or more processors of the computer such that the computer calculates for different treaty durations a stop loss premium for the fleet of vehicles; that the computer calculates for each treaty duration a stop loss premium per vehicle by dividing the stop loss premium, calculated for the treaty duration and for the fleet of vehicles, with the number of vehicles in the fleet; that the computer associates subsets of the fleet of vehicles with the different treaty durations; and that the computer calculates for each treaty duration a stop loss premium for the subset of the fleet of vehicles, associated with the treaty duration, by multiplying the stop loss premium per vehicle, calculated for the respective treaty duration, with the number of vehicles in the respective subset.

18. The Computer program product according to claim 13, comprising further computer program code means for controlling the one or more processors of the computer such that the computer associates subsets of the fleet of vehicles with different treaty durations; that the computer calculates for each treaty duration a duration-dependent loss frequency by dividing an expected total loss for the treaty duration by the maximum individual loss, the expected total loss for a multi-year treaty duration being calculated by adding an expected total loss for each year included in the multi-year treaty.

19. The Computer program product according to claim 18, comprising further computer program code means for controlling the one or more processors of the computer such that the computer calculates an expected total loss for a first year of a multi-year treaty by multiplying an expected number of incidents, expected in the first year, with an average individual loss amount for an incident involving one of the vehicles; that the computer calculates an expected total loss for one of the years after the first year of the multi-year treaty by multiplying an expected total loss of a preceding year with an index; and that the computer calculates an expected total loss for the multi-year treaty by aggregating expected total losses for years included in the multi-year treaty.

20. The Computer program product according to claim 13, comprising further computer program code means for controlling the one or more processors of the computer such that the computer stores a maximum total insurance coverage; that the computer calculates a premium excess based on the loss frequency, the maximum individual loss, and the maximum total insurance coverage as a stop loss premium for an assumed loss distribution having only losses with a value of one of zero and maximum individual loss; and that the computer calculates the premium by subtracting at least a defined part of the premium excess from the premium.

21. The Computer program product according to claim 13, comprising further computer program code means for controlling the one or more processors of the computer such that the computer calculates the premium for defined values of the deductible and produces a graphical representation showing the premium as a function of the defined values of the deductible.

22. The Computer program product according to claim 13, comprising further computer program code means for controlling the one or more processors of the computer such that the computer receives and stores risk factors; that the computer calculates the expected total loss based on the risk factors; and that the computer produces a graphical representation showing the premium as a function of the risk factors.

23. The Computer program product according to claim 13, comprising further computer program code means for controlling the one or more processors of the computer such that the computer calculates the premium for defined values of the expected number of incidents and produces a graphical representation showing the premium as a function of the defined values of the expected number of incidents.

24. The Computer program product according to claim 13, comprising further computer program code means for controlling the one or more processors of the computer such that the computer stores an expected number of incidents involving one of the vehicles; that the computer stores an expected average individual loss amount for an incident involving one of the vehicles; and that the computer calculates the expected total loss by multiplying the expected number of incidents with the expected average individual loss amount.

25. A computer-based data processing system for calculating a premium for stop loss insurance for a fleet of vehicles, the system including:
means for determining an expected total loss for the fleet of vehicles;
means for storing a maximum individual loss equivalent to a cost of a most expensive vehicle of the fleet;
means for calculating a loss frequency by dividing the expected total loss by the maximum individual loss;
means for storing a deductible payable by an insurance holder; and means for calculating the premium based on the loss frequency, the maximum individual loss, and the deductible as a stop loss premium for an assumed loss distribution having only losses with a value of one of zero and maximum individual loss.

26. The system according to claim 25, further including means for associating subsets of the fleet of vehicles with different treaty durations; means for calculating for each treaty duration a separate premium for the subset of the fleet of vehicles associated with the treaty duration; and means for calculating the premium for the fleet of vehicles by aggregating the separate premiums.

27. The system according to claim 25, further including means for associating subsets of the fleet of vehicles with different treaty durations; means for calculating for each treaty duration a stop loss premium for the fleet of vehicles; and means for calculating for each treaty duration a premium for the subset of the fleet of vehicles associated with the treaty duration by weighting the stop loss premium, calculated for the fleet of vehicles, with the number of vehicles in the subset.

28. The system according to claim 25, further including means for associating subsets of the fleet of vehicles with different treaty durations; means for calculating for each treaty duration a duration-dependent loss frequency by dividing an expected total loss for the treaty duration by the maximum individual loss; means for calculating a stop loss premium for the fleet of vehicles for each treaty duration based on the duration-dependent loss frequency, the maximum individual loss, and a deductible assigned to the treaty duration, the stop loss premium being calculated for an assumed loss distribution having only losses with a value of one of zero and maximum individual loss; and means for calculating for each treaty duration a premium for the subset of the fleet of vehicles associated with the treaty duration by dividing the stop loss premium for the treaty duration by the total number of vehicles in the fleet and by the treaty duration, and by multiplying the stop loss premium for the treaty duration with the number of vehicles in the subset.

29. The system according to claim 25, further including means for calculating for different treaty durations stop loss premiums for the fleet of vehicles; means for calculating for each treaty duration a stop loss premium per vehicle by dividing the stop loss premium, calculated for the treaty duration and for the fleet of vehicles, with the number of vehicles in the fleet; means for associating subsets of the fleet of vehicles with the different treaty durations; and means for calculating for each treaty duration a stop loss premium for the subset of the fleet of vehicles associated with the treaty duration by multiplying the stop loss premium per vehicle, calculated for the respective treaty duration, with the number of vehicles in the respective subset.

30. The system according to claim 25, further including means for associating subsets of the fleet of vehicles with different treaty durations; means for calculating for each treaty duration a duration-dependent loss by dividing an expected total loss for the treaty duration by the maximum individual loss, the expected total loss for a multi-year treaty duration being calculated by adding an expected total loss for each year included in the multi-year treaty.

31. The system according to claim 30, further including means for calculating an expected total loss for a first year of a multi-year treaty by multiplying an expected number of incidents expected in the first year with an average individual loss amount for an incident involving one of the vehicles; means for calculating an expected total loss for one of the years after the first year of the multi-year treaty by multiplying an expected total loss of a preceding year with an index; and means for calculating an expected total loss for the multi-year treaty by aggregating expected total losses for years included in the multi-year treaty.

32. The system according to claim 25, further including means for storing a maximum total insurance coverage; means for calculating a premium excess based on the loss frequency, the maximum individual loss, and the maximum total insurance coverage as a stop loss premium for an assumed loss distribution having only losses with a value of one of zero and maximum individual loss; and means for calculating the premium by subtracting at least a defined part of the premium excess from the premium.

33. The system according to claim 25, further including means for calculating the premium for defined values of the deductible; and means for producing a graphical representation showing the premium as a function of the defined values of the deductible.

34. The system according to claim 25, further including means for receiving and storing risk factors; means for calculating the expected total loss based on the risk factors; and means for producing a graphical representation showing the premium as a function of the risk factors.

35. The system according to claim 25, further including means for calculating the premium for defined values of the expected number of incidents; and
means for producing a graphical representation showing the premium as a function of the defined values of the expected number of incidents.

36. The system according to claim 25, further including means for storing an expected number of incidents involving one of the vehicles; means for storing an expected average individual loss amount for an incident involving one of the vehicles; and means for calculating the expected total loss by multiplying the expected number of incidents with the expected average individual loss amount.
